(19) United States
(12) Patent Application Publication
(10) Pub. No.: US 2024/0282208 A1
(43) Pub. Date: Aug. 22, 2024

(54) ELECTRONIC DEVICE AND DISPLAY METHOD FOR VIDEO CONFERENCE OR VIDEO TEACHING

(71) Applicant: PEGATRON CORPORATION, Taipei City (TW)

(72) Inventors: Chia-Liang Chiang, Taipei City (TW); Po-Sen Chen, Taipei City (TW); Ching-Hao Yu, Taipei City (TW); Tsai-Chien Kao, Taipei City (TW); Cyuan-Yue Jhong, Taipei City (TW); Tao-Hua Cheng, Taipei City (TW)

(73) Assignee: PEGATRON CORPORATION, TAIPEI CITY (TW)

(21) Appl. No.: 18/171,375

(22) Filed: Feb. 20, 2023

(30) Foreign Application Priority Data
Mar. 21, 2022 (TW) 111110298

(51) Int. Cl. G09B 5/06; G06F 3/14; G06T 7/194; G06V 10/44; H04N 7/15

(52) U.S. Cl. CPC G09B 5/065; G06F 3/14; G06T 7/194; G06V 10/44; H04N 7/15

(57) ABSTRACT

An electronic device and a display method for video conference or video teaching. The electronic device includes an image capturing unit, a display, an input unit, and a processor. The image capturing unit captures a first document image of a physical document. The input unit generates annotation information. The processor controls the display to display the first document image. When the processor receives the annotation information during a period of time that the image capturing unit is capturing the first document image and the display is simultaneously displaying the first document image, the processor controls the display to simultaneously display the first document image and the annotation information.

### CROSS-REFERENCE TO RELATED APPLICATION

This application claims the priority benefit of Taiwan application serial no. 111110298, filed on Mar. 21, 2022. The entirety of the above-mentioned patent application is hereby incorporated by reference herein and made a part of this specification.

### BACKGROUND

### Technology Field

The disclosure relates to an electronic device and a display method, and in particular, to an electronic device and a display method for video conference or video teaching.

### Description of Related Art

In recent years, the demand for video teaching and video conference has increased rapidly. Software files may be shared in video teaching or video conference through existing video software. However, if a physical document (such as a teacher's handout, an official document, etc.) needs to be shared with an audience in the video, a speaker has to show the physical document in front of the camera.

Operationally, if the speaker needs to share the physical document or guide a reading, he or she has to hold the physical document in front of the camera. The above-mentioned method is prone to be shaky, and the image ratio of the physical document is too small, resulting in the problem that the audience in video teaching and video conference cannot see the content clearly. In addition, if the speaker needs to immediately mark the key points or annotations on the physical document for auxiliary explanation, the physical document is bound to be covered. In light of the above, in the process of video conference or video teaching, when the physical document needs to be shared with the audience in the video, the conventional operation method greatly displeases the user experience for the speaker and the audience.

### SUMMARY

The disclosure provides an electronic device and a display method for video conference or video teaching, which can improve the user experience and convenience for a speaker and an audience when a physical document needs to be shared with the audience in the video.

The electronic device of the disclosure is adapted for video conference or video teaching. The electronic device includes a first image capturing unit, a display, an input unit, and a processor. The first image capturing unit captures a first document image of a physical document. The input unit generates annotation information. The processor is coupled to the first image capturing unit, the display, and the input unit. The processor controls the display to display the first document image. When the processor receives the annotation information during a period of time that the first image capturing unit is capturing the first document image and the display is simultaneously displaying the first document image, the processor controls the display to simultaneously display the annotation information and the first document image.

The display method of the disclosure is adapted for an electronic device in video conference or video teaching. The electronic device includes a first image capturing unit, a display, and an input unit. The display method includes: a first document image of a physical document is captured by the first image capturing unit; the first document image is displayed by the display; when annotation information from the input unit is received during a period of time that the first image capturing unit is capturing the first document image and the display is simultaneously displaying the first document image, the display is controlled to simultaneously display the annotation information and the first document image.

Based on the above, when the annotation information is received during the period of time that the first image capturing unit is capturing the first document image and the display is simultaneously displaying the first document image, the disclosure simultaneously displays the annotation information and the first document image. Therefore, in the case of sharing or guiding a reading of the physical document, the disclosure may add the annotation information to the first document image to mark the first document image. In this way, the first document image is not shaky, and the problem that the audience of video teaching and video conference cannot see the content clearly due to the small image ratio may not occur. When the speaker is sharing the physical document or guiding the reading, the first document image is not obscured. In light of the above, the disclosure can effectively improve the user experience and convenience.

In order to make the aforementioned features and advantages of the disclosure comprehensible, embodiments accompanied with drawings are described in detail as follows.

### BRIEF DESCRIPTION OF THE DRAWINGS

FIG. 1 is a schematic diagram of an operation scenario of an electronic device according to an embodiment of the disclosure.

FIG. 2 is a schematic diagram of an electronic device according to a first embodiment of the disclosure.

FIG. 3 is a flowchart of a first method according to the display method shown in FIG. 2.

FIG. 4 is a flowchart of a second method according to the display method shown in FIG. 2.

FIGS. 5A and 5B are schematic diagrams of the operation interface shown in FIG. 2.

FIG. 6 is an operation flowchart according to FIG. 2.

FIG. 7 is a schematic diagram of an electronic device according to a second embodiment of the disclosure.

FIG. 8 is a flowchart of the display method shown in FIG. 7.

FIG. 9 is a schematic diagram of the operation interface shown in FIG. 7.

FIG. 10 is a flowchart of operation according to FIG. 7.

### DESCRIPTION OF THE EMBODIMENTS

Some embodiments of the disclosure accompanied with drawings are described in detail as follows. The reference numerals used in the following description are regarded as the same or similar elements when the same reference numerals appear in different drawings. These embodiments are only a part of the disclosure, and do not disclose all the possible implementations of the disclosure. To be more precise, the embodiments are only examples in the scope of the claims of the disclosure.

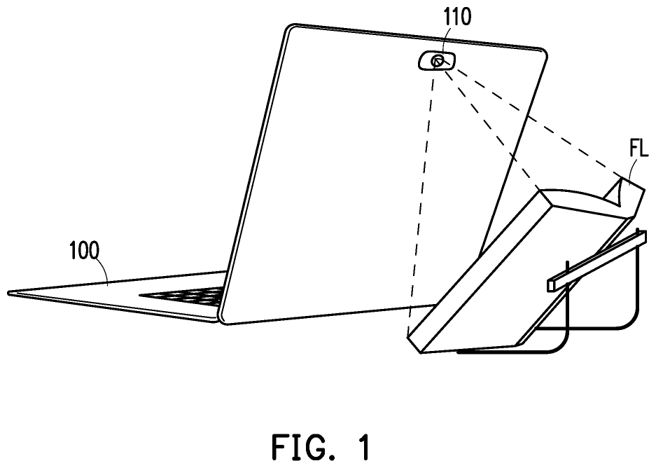

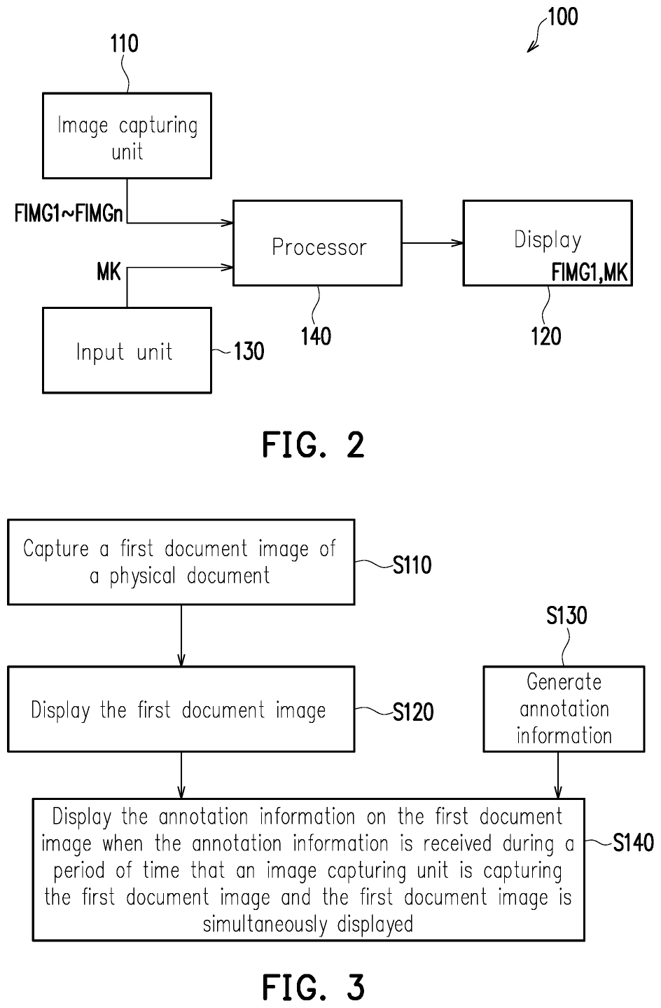

Please refer to FIGS. 1 and 2 jointly. FIG. 1 is a schematic diagram of an operation scenario of an electronic device according to an embodiment of the disclosure. FIG. 2 is a schematic diagram of an electronic device according to a first embodiment of the disclosure. In the embodiment, an electronic device 100 may be a device adapted for video conference or video teaching. The electronic device 100 may be a desktop computer, a laptop computer, a tablet computer, a smart phone, or the like. In this embodiment, the electronic device 100 is a laptop computer. In the embodiment, the electronic device 100 includes an image capturing unit 110, a display 120, an input unit 130, and a processor 140. The image capturing unit 110 captures at least one of document images FIMG1-FIMGn of a physical document FL. The physical document FL is, for example, a book, a printed handout, or an official document. The document images FIMG1-FIMGn are, for example, images of different pages of the physical document FL (the disclosure is not limited thereto). In the embodiment, the image capturing unit 110 may be a camera. In the embodiment, the image capturing unit 110 is disposed on the back cover of the laptop computer. Therefore, the image capturing unit 110 is a rear-facing camera (or referred to as a world facing camera). In some embodiments, the image capturing unit 110 may be externally connected to the electronic device 100. When the physical document FL is fixed by a fixing member (e.g., a bookshelf), the image capturing unit 110 may capture at least one of the document images FIMG1-FIMGn of the physical document FL in real time. In the embodiment, the input unit 130 is adapted to generate annotation information MK. For example, a user provides the annotation information MK through, for example, the input unit 130. The input unit 130 may be an element such as a stylus, a mouse, a traceball, and the like. For another example, the input unit 130 may be a touch panel of the display 120. The user may use a finger to perform a touch operation on the touch panel of the display 120 to generate a marking trace pattern to provide the annotation information MK.

In the embodiment, the processor 140 is coupled to the image capturing unit 110, the display 120, and the input unit 130. The processor 140 controls the display 120 to display one of the document images FIMG1-FIMGn. In the embodiment, based on the video requirements, when the image capturing unit 110 is capturing the document image FIMG1, the display 120 displays the document image FIMG1 in real time simultaneously. In some embodiments, when the image capturing unit 110 captures one of the document images FIMG1-FIMGn, the display 120 is controlled to display one of the document images FIMG1-FIMGn. The disclosure is not limited to the timing at which the document images FIMG1-FIMGn are being displayed.

In the embodiment, the display 120 may be a liquid crystal display (LCD), a light-emitting diode (LED), an organic light-emitting diode (OLED), etc. or any display device for providing a display function, or a screen that uses a cold cathode fluorescent lamp (CCFL) or a light-emitting diode (LED) as the backlight module. The processor 140 is, for example, a central processing unit (CPU), or other programmable general-purpose or special-purpose microprocessors, a digital signal processor (DSP), a programmable controller, an application specific integrated circuit (ASIC), a programmable logic device (PLD), or other similar devices or a combination of the aforementioned devices, which may load and execute a computer program.

When the processor 140 receives the annotation information MK during a period of time that the image capturing unit 110 is capturing the document image FIMG1 and the display 120 is simultaneously displaying the document image FIMG1 (e.g., a first document image), the processor 140 controls the display 120 to simultaneously display the annotation information MK and the document image FIMG1. In the embodiment, the annotation information MK is at least one marking trace pattern generated by the user of the electronic device 100 through the input unit 130. For example, the user of the electronic device 100 may use a stylus, a mouse, a traceball, or a finger to perform a touch operation on the touch screen of the display 120 to generate the marking trace pattern.

For example, the user is, for example, a speaker. The user may perform a marking operation on the document image FIMG1 of the physical document FL to generate the annotation information MK. The processor 140 controls the display 120 to display the annotation information MK on the document image FIMG1. Therefore, a participant may see the document image FIMG1 of the physical document FL and the annotation information MK on the display 120.

It is worth mentioning here that when the processor 140 receives the annotation information MK during the period of time that the image capturing unit 110 is capturing the document image FIMG1 and the display 120 is simultaneously displaying the document image FIMG1, the processor 140 controls the display 120 to simultaneously display the annotation information MK and the document image FIMG1. Therefore, when the user shares or guides a reading of the physical document, the processor 140 may use the annotation information MK to mark the document image FIMG1. The user does not need to hold the physical document FL. In this way, the document image FIMG1 of the physical document FL is not shaky, and the problem that the participant of video teaching and video conference cannot see the content clearly due to the small image ratio may not occur. In addition, when the user is sharing the physical document or guiding a reading, the document image FIMG1 is not obscured. In light of the above, the electronic device 100 can effectively improve the user experience and convenience for the user.

In the embodiment, the processor 140 obtains a feature value F1 of the document image FIMG1. The processor 140 uses the feature value F1 to identify the current document image (e.g., a second document image) displayed on the display 120. When the feature value of the current document image matches the feature value F1 of the document image FIMG1, the processor 140 determines that the current document image matches the document image FIMG1, that is, the current document image and the document image FIMG1 are images of the same page in the physical document FL. Therefore, the processor 140 controls the display 120 to simultaneously display the annotation information MK and the current document image. On the other hand, when the feature value of the current document image does not match the feature value F1 of the document image FIMG1, the processor 140 determines that the current document image is a document image other than the document image FIMG1. Therefore, the processor 140 controls the display 120 not to display the annotation information MK on the current document image.

It should be noted that the processor 140 can use the feature value F1 to identify the current document image, so as to determine whether to enable the display 120 to simultaneously display the annotation information MK and the current document image. In this way, when the same page of the physical document FL is displayed again, the annotation information MK is also displayed immediately.

In the embodiment, the processor 140 may obtain the feature value F1 of the document image FIMG1 through, for example, a deep learning model

In the embodiment, the processor 140 obtains a relative position between the document image FIMG1 and the annotation information MK (or a marking feature value of the annotation information MK). Therefore, when the current document image matched with the document image FIMG1 is displayed, the annotation information MK is positioned on the current document image based on the relative position between the document image FIMG1 and the annotation information MK. Therefore, the annotation information MK is displayed at the correct position on the current document image. Further, the feature value of the annotation is associated with the position of the feature value of the document image FIMG1. Therefore, even if the document image FIMG1 is shifted or zoomed, the annotation information MK is changed accordingly.

Please refer to FIGS. 2 and 3 at the same time. FIG. 3 is a flowchart of the display method shown in FIG. 2. The display method of the embodiment is adapted for the electronic device 100. In step S110, the first document image (e.g., the document image FIMG1) of the physical document FL is captured. In the embodiment, the first document image may be captured by the image capturing unit 110. In step S120, the processor 140 controls the display 120 to display the first document image. In step S130, the input unit 130 generates the annotation information MK. In step S140, when the annotation information MK is received during the period of time that the image capturing unit 110 is capturing the first document image and the first document image is simultaneously displayed, the annotation information MK is displayed on the first document image. In the embodiment, step S140 may be performed by the processor 140. The implementation details of steps S110 to S140 may be sufficiently taught from the embodiments of FIGS. 1 and 2, so the descriptions are not repeated here.

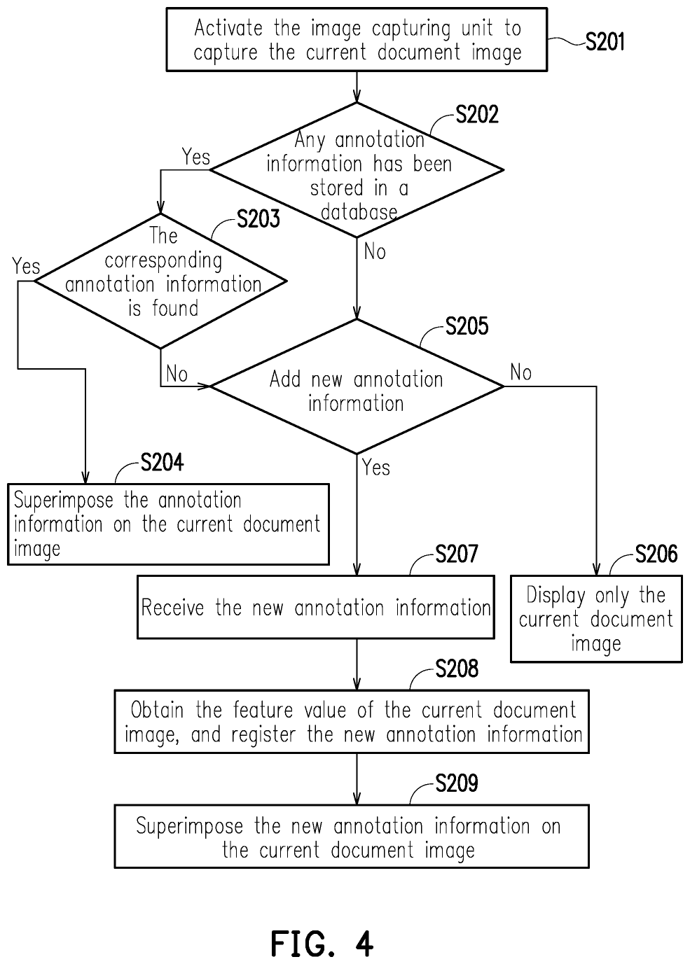

Please refer to FIG. 4, which is a second flowchart of the display method shown in FIG. 2. The display method of the embodiment is adapted for the processor 140 of the electronic device 100. In step S201, the processor 140 activates the image capturing unit 110 to capture the current document image. The processor 140 determines whether any annotation information has been stored in a database (not shown) of the electronic device 100 in step S202. When the database is determined to have the annotation information stored, the processor 140 determines whether the current document image matches the document image FIMG1. Taking the feature value F1 of the document image FIMG1 as an example, the processor 140 uses the feature value F1 to identify the current document image. When the feature value of the current document image matches the feature value F1, the processor 140 determines that the current document image matches the document image FIMG1 and identifies the current document image. Therefore, the processor 140 further searches for the annotation information corresponding to the document image FIMG1 in step S203. Further, once annotation information is received, the processor 140 registers the annotation information and stores the annotation information in the database. When the display 120 displays the current document image, the processor 140 first checks whether the database stores any annotation information in step S202. If there is annotation information stored in the database, the processor 140 searches for the corresponding annotation information based on the feature value of the current document image in step S203. Next, the processor 140 obtains the relative position between the document image and the corresponding annotation information. Therefore, the processor 140 superimposes the annotation information on the current document image in step S204.

On the other hand, if the processor 140 does not find the corresponding annotation information in step S203, it means that the annotation information corresponding to the current document image may be removed. Therefore, the processor 140 determines whether to add a new annotation information in step S205.

Please go back to step S202. When the current document image is determined not to have the corresponding annotation information, it means that no annotation information corresponding to the current document image is stored in the database. Therefore, the processor 140 determines whether to add new annotation information in step S205.

In step S205, when no new annotation information is received, the processor 140 controls the display 120 to display only the current document image in step S206. On the other hand, when the image capturing unit 110 is activated and new annotation information is received during the display of the current document image, the processor 140 receives the new annotation information in step S207. The processor 140 obtains the feature value of the current document image and registers the new annotation information in step S208, and superimposes the new annotation information on the current document image in step S209.

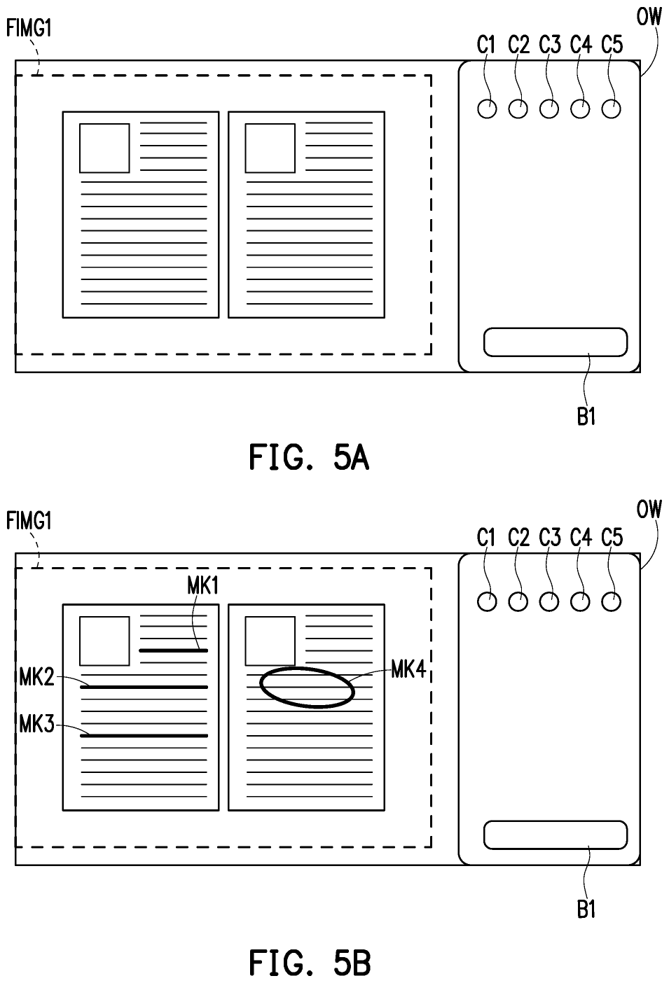

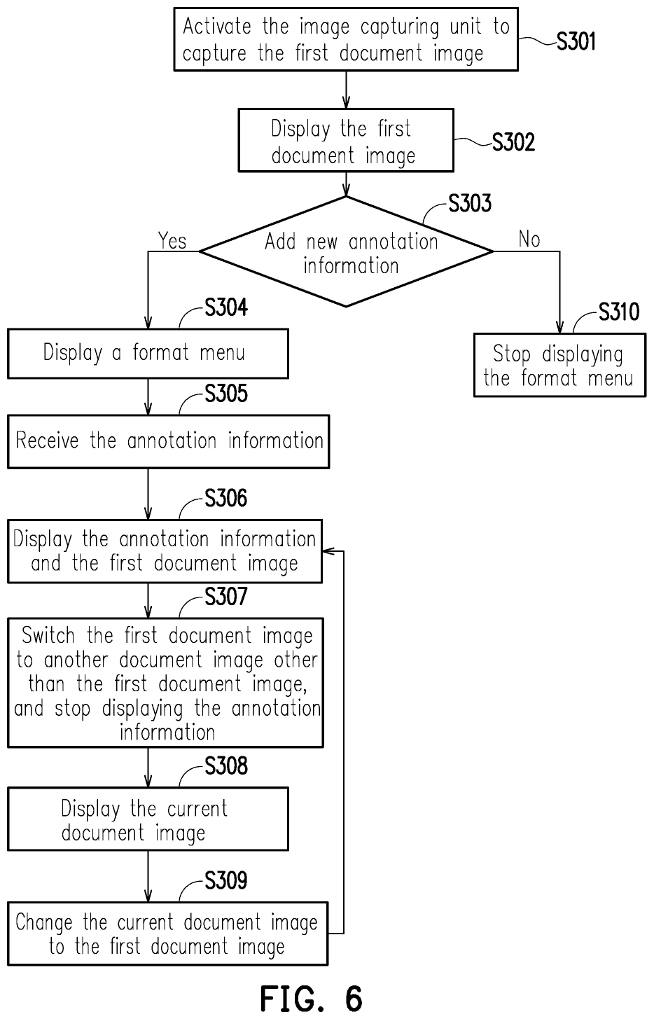

Please refer to FIGS. 2, 5A, 5B, and 6 together. FIGS. 5A and 5B are schematic diagrams of the operation interface shown in FIG. 2. FIG. 6 is an operation flowchart according to FIG. 2. The embodiment takes the operation of the first document image (e.g., the document image FIMG1) as an example. In the embodiment, in step S301, the operation flow starts. The image capturing unit 110 is activated to capture the document image. In step S302, the first document image is displayed, as shown in FIG. 5A. In step S303, whether the annotation information MK is to be added is determined. In the embodiment, the user may perform an operation on the operation interface. The processor 140 determines whether the user has an intention to add the annotation information MK based on the operation performed by the user on the operation interface. In step S303, when it is determined that the user is to add the annotation information MK, the processor 140 controls the display 120 to display a format menu and provides the format of the annotation information MK in step S304. In the embodiment, the processor 140 provides an operation window OW in step S304. The operation window OW includes, for example, color selection icons C1 to C5 and a save icon B1 (the disclosure is not limited thereto). The user may at least select a color for the annotation information MK from the color selection icons C1 to C5.

In step S305, the annotation information MK is received. In step S305, the processor 140 receives the annotation information MK. Therefore, in step S306, the processor 140 controls the display 120 to display the annotation information MK and the document image FIMG1. For example, the annotation information MK includes marking traces MK1 to MK4, as shown in FIG. 5B. The annotation information MK and the document image FIMG1 are presented to other participants (e.g. the audience) at the same time through the operation interfaces.

It should be understood that, based on the above-mentioned operation, the participant can also mark the document image FIMG1 received through the operation interface to generate annotation information.

In addition, in step S306, the user may click the save icon B1 to save a composite picture file of the annotation information MK and the first document image.

In step S307, the user changes the page of the physical document FL, and switches the first document image to another document image other than the first document image (e.g., a document image that does not match the feature value F1). Therefore, the annotation information MK corresponding to the first document image is stopped from being displayed. Taking the document image FIMG1 as an example, the processor 140 uses the feature value F1 to identify the current document image. When the current document image does not match the feature value F1 of the document image FIMG1, the processor 140 determines that the current document image and the document image FIMG1 do not belong to the same page of the physical document FL. Therefore, the processor 140 controls the display 120 not to display the annotation information MK. That is, when the current document image displayed on the display 120 does not match the document image FIMG1, the processor 140 controls the display 120 to stop displaying the annotation information MK. Therefore, in step S308, the display 120 only displays the current document image. The current document image is displayed on the operation interfaces of other participants.

In addition, in step S308, the user may click the save icon B1 to save a picture file of the current document image.

In step S309, the user changes the page of the physical document FL back to the page of the first document image. For example, the processor 140 determines that the current document image matches the document image FIMG1. Therefore, the processor 140 returns to the operation of step S306.

Please go back to step S303. When it cannot be determined whether the user is to add the annotation information MK, the processor 140 enters the operation of step S310 to control the display 120 to stop displaying the format menu. Therefore, the annotation information MK is stopped from being generated.

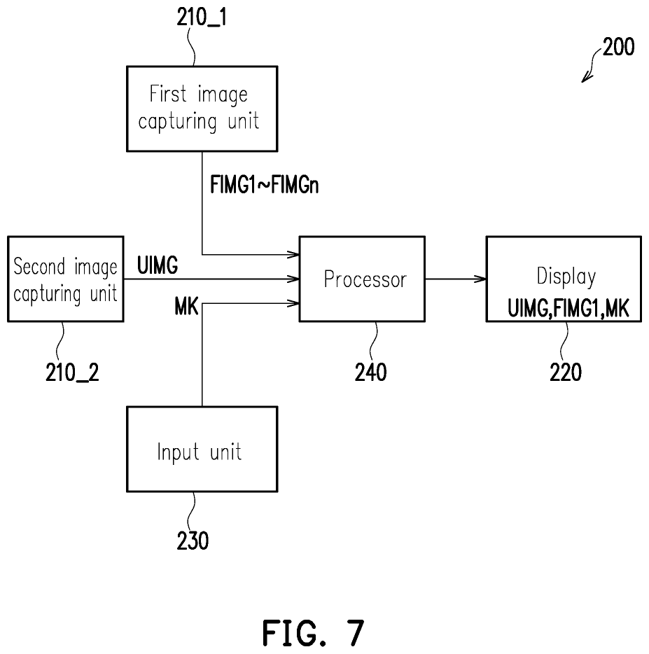

Please refer to FIG. 7, which is a schematic diagram of an electronic device according to a second embodiment of the disclosure. In the embodiment, an electronic device 200 includes image capturing units 210_1 and 210_2, a display 220, and a processor 240. The operation details of the image capturing unit 210_1 may be referred to the operation details of the image capturing unit 110 in FIGS. 1 and 2, so the descriptions are not repeated here. In the embodiment, the implementation of the display 220 being controlled to display the annotation information MK on the document image FIMG1 may have been sufficiently taught in the various embodiments of FIGS. 1 to 6, so the descriptions are not repeated here.

In the embodiment, the image capturing unit 210_2 captures a user image UIMG of the user of the electronic device 200. The user image UIMG is, for example, a real-time dynamic image. In the embodiment, the image capturing unit 210_2 is coupled to the processor 240. The processor 240 receives the user image UIMG, and controls the display 220 to display the user image UIMG. In this way, other participants may see the user of the electronic device 200. In the embodiment, the image capturing unit 210_2 is disposed on, for example, the display surface of the display 220, and the lens of the image capturing unit 210_2 faces toward the display direction of the display 220. Therefore, the image capturing unit 210_2 is, for example, a front-facing camera (or referred to as a user facing camera).

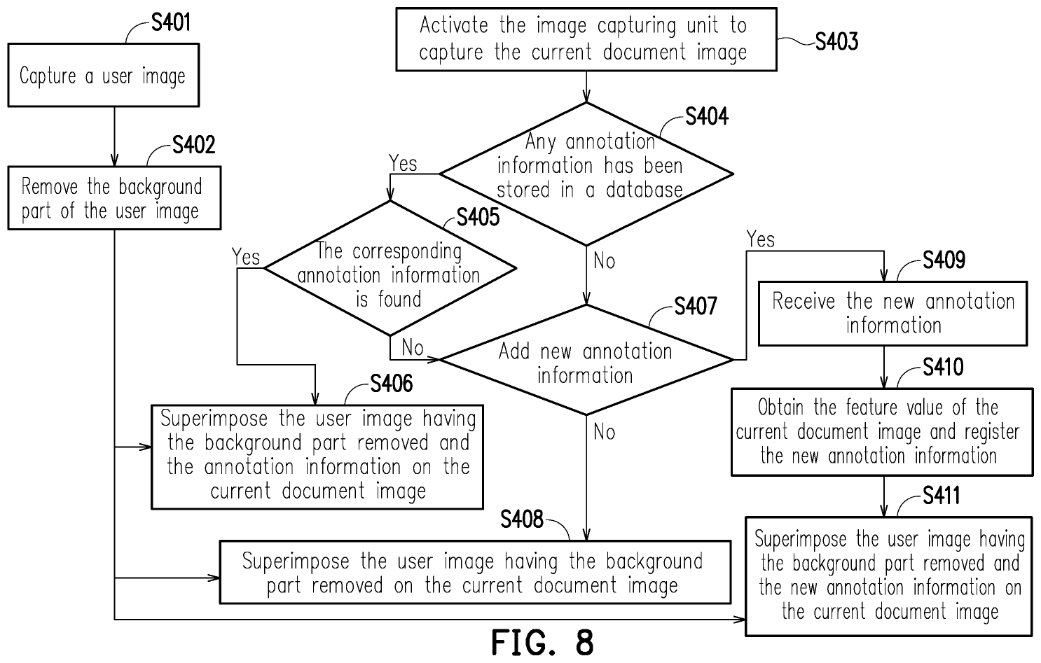

Please refer to FIGS. 7 and 8 together. FIG. 8 is a flowchart of the display method shown in FIG. 7. In the embodiment, the display method is adapted for the electronic device 200. In step S401, the user image UIMG is captured. In step S402, the background in the user image UIMG is removed. In step S402, the processor 240 identifies the background and removes the background in the user image UIMG. For example, in step S402, the processor 240 segments the background part through, for example, a semantic segmentation model, and only retains the user image UIMG whose background part has been removed. In some embodiments, the processor 240 segments the background part through, for example, other image classification models.

In step S403, the image capturing unit is activated to capture the current document image. In step S404, the processor 240 determines whether any annotation information has been stored in the database (not shown). When the database is determined to have annotation information stored, the processor 240 further searches for the corresponding annotation information in step S405. The operations of steps S403 to S405 are similar to the operations of steps S201 to S203 of FIG. 4. The operation details of steps S403 to S405 have been clearly described in steps S201 to S203 of FIG. 4, so the descriptions are not repeated here.

In the embodiment, if the processor 240 finds the annotation information corresponding to the current document image in step S405, it means that the annotation information corresponding to the current document image is kept. Therefore, the processor 240 superimposes the user image UIMG having the background part removed and the annotation information on the current document image in step S406.

On the other hand, if the processor 240 does not find the annotation information corresponding to the current document image in step S405, it means that the annotation information corresponding to the current document image may be removed. Therefore, the processor 240 determines whether to add new annotation information in step S407.

Please go back to step S404. When there is no annotation information stored in the database, the processor 240 determines whether to add new annotation information in step S407.

In step S407, when no annotation information is received, the processor 240 controls the display 220 to superimpose the user image UIMG having the background part removed on the current document image in step S408. On the other hand, when the processor 240 receives new annotation information in step S409, the processor 240 obtains the feature value of the current document image and registers the new annotation information in step S410, and superimposes the user image UIMG having the background part removed and the new annotation information on the current document image in step S411.

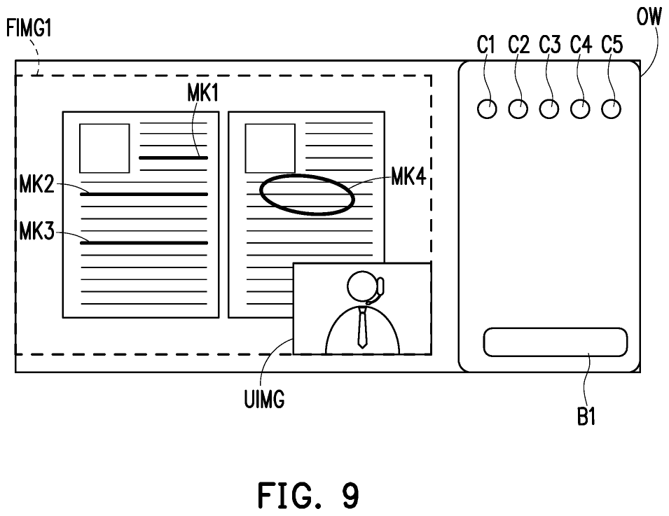

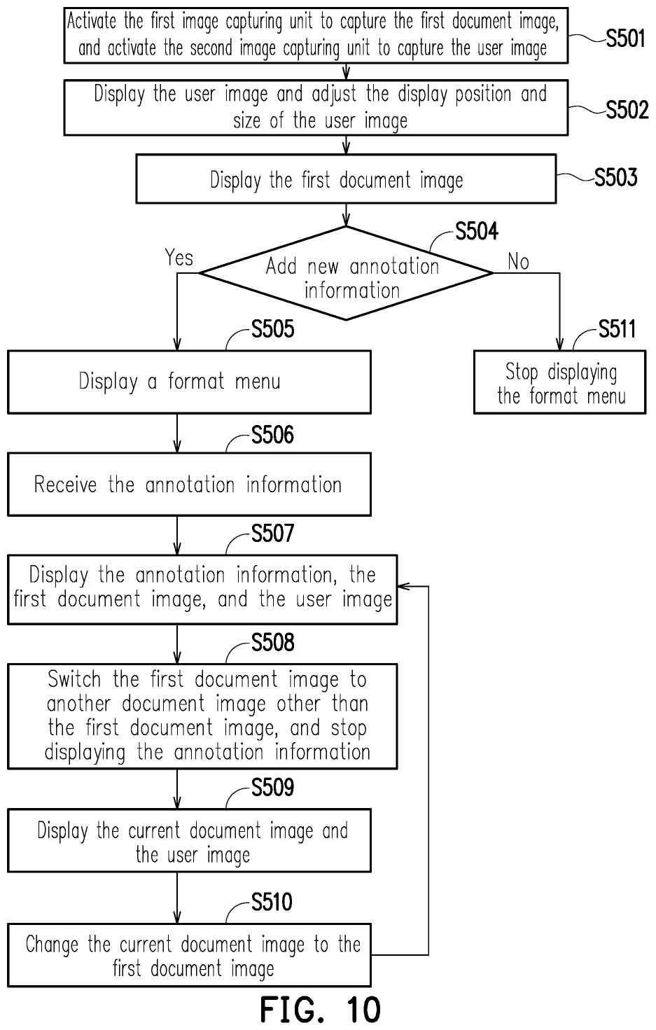

Please refer to FIGS. 7, 9, and 10 together. FIG. 9 is a schematic diagram of the operation interface shown in FIG. 7. FIG. 10 is a flowchart of operation according to FIG. 7. In the embodiment, in step S501, the operation starts. The image capturing unit 210_1 is activated to capture the first document image (e.g., the document image FIMG1). The image capturing unit 210_2 is activated to capture the user image UIMG.

In step S502, the user image UIMG is displayed. The display position and the size of the user image UIMG are to be adjusted. In step S503, the first document image is displayed. For example, the processor 240 controls the display 220 to display the user image UIMG. The user may drag the user image UIMG through the operation interface to adjust the display position of the user image UIMG, and drag the edge of the user image UIMG to adjust the size of the user image UIMG, as shown in FIG. 9.

In step S504, whether the annotation information MK is to be added is determined. In step S504, when the user adds the annotation information MK, the processor 240 displays a format menu in step S505. Therefore, the user may select the format of the annotation information MK from the format menu. In step S506, the annotation information MK is received. Therefore, in step S507, the processor 240 controls the display 220 to display the annotation information MK, the first document image, and the user image UIMG. For example, the annotation information MK includes the marking traces MK1 to MK4, as shown in FIG. 9. The annotation information MK, the document image FIMG1, and the user image UIMG are presented to the other participants through the operation interfaces. Therefore, the other participants may see the user image UIMG. In addition, in step S507, the user may click the save icon B1 to save the composite image file of the annotation information MK and the first document image.

In step S508, the user changes the physical document FL and switches the first document image to another document image other than the first document image (e.g., a document image that does not match the feature value F1). Therefore, the annotation information MK corresponding to the first document image is stopped from being displayed. Thus, in step S509, the display 220 displays the current document image and the user image UIMG. The current document image and the user image UIMG are presented to the other participants through the operation interfaces. In addition, in step S509, the user may click the save icon B1 to save the picture file of the current document image.

In step S510, the user changes the page back to the original page. The processor 240 determines that the current document image (i.e., the document image matching the feature value F1) matches the first document image. Therefore, the processor 240 returns to step S507 to control the display 220 to display the annotation information MK, the first document image, and the user image UIMG.

In step S504, whether the user adds the annotation information MK cannot be determined, the processor 240 enters the operation of step S511 to control the display 220 to stop displaying the format menu. Therefore, the annotation information MK is stopped from being generated.

To sum up, when the annotation information is received during the period of time that the document image is being captured and the document image is being simultaneously displayed, the disclosure simultaneously displays the annotation information and the document image. Therefore, when a reading of the physical document is shared or guided, the disclosure may add annotation on the document image currently displayed without the user holding the physical document. In this way, the document image is not shaky due to hand movements, and the problem that the other participants in video teaching and video conference cannot see the content clearly because the image ratio is too small may not occur. When the speaker is sharing the physical document or guiding a reading, the document image seen by the audience is not obscured by the speaker. In light of the above, the disclosure can effectively improve the user experience and convenience for the user. In addition, the disclosure utilizes the feature value to identify the current document image, so as to determine whether the annotation information is going to be displayed. In this way, when the document image matched is displayed again, the annotation information is also displayed immediately.

Although the disclosure has been described with reference to the above embodiments, the described embodiments are not intended to limit the disclosure. People of ordinary skill in the art may make some changes and modifications without departing from the spirit and the scope of the disclosure. Thus, the scope of the disclosure shall be subject to those defined by the attached claims.

What is claimed is:

1. An electronic device for video conference or video teaching, comprising:
a first image capturing unit, configured to capture a first document image of a physical document;
a display;
an input unit, configured to generate annotation information; and
a processor, coupled to the first image capturing unit, the display, and the input unit, configured to control the display to display the first document image, wherein the processor controls the display to simultaneously display the first document image and the annotation information when the processor receives the annotation information from the input unit during a period of time that the first image capturing unit is capturing the first document image and the display is simultaneously displaying the first document image.

2. The electronic device according to claim 1, wherein the first image capturing unit is further configured to capture a second document image of the physical document, and the processor further obtains a feature value of the first document image, identifies the second document image according to the feature value, and controls the display to simultaneously display the second document image and the annotation information.

3. The electronic device according to claim 2, wherein:
the processor further obtains a relative position between the first document image and the annotation information, and when the annotation information is displayed on the second document image, the annotation information is positioned on the second document image based on the relative position.

4. The electronic device according to claim 2, wherein the processor further checks whether the annotation information is stored in a database, and when the database does not have the annotation information, the processor registers the annotation information and stores the annotation information in the database.

5. The electronic device according to claim 2, wherein:
when the second document image does not match the feature value, the processor controls the display not to display the annotation information.

6. The electronic device according to claim 1, further comprising:
a second image capturing unit, coupled to the processor, and configured to capture a user image of a user,
wherein the processor controls the display to display the user image.

7. The electronic device according to claim 6, wherein the processor removes a background part of the user image.

8. The electronic device according to claim 7, wherein:
the processor segments the background part through a semantic segmentation model.

9. A display method adapted for an electronic device in video conference or video teaching, and the electronic device comprising a first image capturing unit, a display, and an input unit, the display method comprising:
capturing, by the first image capturing unit, a first document image of a physical document;
displaying, by the display, the first document image;
generating, by the input unit, annotation information; and
controlling the display to simultaneously display the annotation information and the first document image when the annotation information from the input unit is received during a period of time that the first image capturing unit is capturing the first document image and the display is simultaneously displaying the first document image.

10. The display method according to claim 9, further comprising:
obtaining a feature value of the first document image;
capturing, by the first image capturing unit, a second document image of the physical document; and
identifying the second document image according to the feature value, and controlling the display to simultaneously display the annotation information and the second document image.

11. The display method according to claim 10, wherein obtaining the feature value of the first document image comprises:
checking whether the annotation information is stored in a database; and
registering the annotation information and storing the annotation information in the database when the database does not have the annotation information.

12. The display method according to claim 10, further comprising:
obtaining a relative position between the first document image and the annotation information; and
positioning the annotation information on the second document image based on the relative position when the annotation information is displayed on the second document image.

13. The display method according to claim 9, further comprising:
controlling the display not to display the annotation information when the second document image does not match the feature value.

14. The display method according to claim 9, further comprising:
capturing, by a second image capturing unit, a user image of a user.

15. The display method according to claim 14, further comprising:
removing a background part of the user image.

16. The display method according to claim 15, further comprising:
segmenting the background part through a semantic segmentation model.
